(19) United States
(12) Patent Application Publication
(10) Pub. No.: US 2026/0280120 A1
(43) Pub. Date: Sep. 17, 2026

(54) BASE STATION ANTENNAS HAVING METAL TUNING ELEMENTS THAT MOVE IN RESPONSE TO CHANGES IN A REMOTE ELECTRONIC TILT SETTING

(71) Applicant: Outdoor Wireless Networks LLC, Claremont, NC (US)

(72) Inventors: Rongrong ZHANG, Suzhou, Jiangsu (CN); Haifei QIN, Suzhou, Jiangsu (CN); Shengtao WANG, Suzhou, Jiangsu (CN)

(21) Appl. No.: 18/874,045

(22) PCT Filed: Jun. 30, 2022
(86) PCT No.: PCT/CN2022/102691

§ 371 Date: Dec. 11, 2024

(51) Int. Cl. H01Q 3/32; H01Q 1/24; H01Q 1/52; H01Q 3/00

(52) U.S. Cl. CPC H01Q 3/32; H01Q 1/246; H01Q 1/521; H01Q 3/005

(57) ABSTRACT

A base station comprises a reflector, remote electronic tilt actuator, an array of radiating elements, the radiating elements mounted to extend forwardly from the reflector, and a first metal tuning element that is at least partly positioned in front of the reflector. The first metal tuning element is configured to move when a remote electronic downtilt setting for the array of radiating elements is changed.

### FIELD OF THE INVENTION

The present invention relates to base station antennas and, in particular, to base station antennas having remote electronic tilt (“RET”) capabilities and metal tuning elements that are used to tune a parameter of an array of radiating elements included in the antenna.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with fixed and mobile subscribers that are positioned throughout the cell. Most base station antennas include one or more phase-controlled arrays of radiating elements such as patch or dipole radiating elements. The phase-controlled arrays of radiating elements are designed to concentrate the RF energy that is transmitted in or received from certain directions. The “gain” of an array of radiating elements in a given direction is a measure of the ability of the array to focus the RF energy in that direction. The “radiation pattern” of an array of radiating elements—which is also referred to as an “antenna beam”—is a compilation of the gain of the array across all different directions. Arrays that have higher gains support higher capacity communications. Typically, the arrays are implemented using dual-polarized radiating elements such as slant −45°/+45° cross-dipole radiating elements. When an array is formed using dual-polarized radiating elements are used, the array can simultaneously generate two separate antenna beams.

Most arrays of radiating elements included in base station antennas that operate under second generation (“2G”), third generation (“3G”) or fourth generation (“4G”) cellular network protocols comprise a single, vertically-extending column of radiating elements. Such arrays are often referred to as “linear arrays.” Linear arrays are typically designed to generate a static antenna beam (i.e., the shape and pointing direction of the antenna beam do not change) that provides service to a pre-defined coverage area such as a cell or a portion thereof that is referred to as a “sector.” Most cells in a cellular communications network are divided into three sectors in the horizontal or “azimuth” plane, with each sector served by a separate base station antenna. Thus, most linear arrays of radiating elements are designed to generate antenna beams that have half power beamwidths in the azimuth plane of about 65°, which provides good coverage to a 120° sector.

Since the linear arrays include multiple radiating elements that are aligned in the vertical direction, each linear array concentrates the RF energy in the vertical or “elevation” plane so that the half power beamwidth in the elevation plane is typically much smaller (e.g., 15-30°) than the half power beamwidth in the azimuth plane. The smaller elevation beamwidth increases the gain of the linear array.

When a cellular network operator adds a new cell to a cellular communications system, it is typically necessary to reduce the “size” of one or more sectors of the adjacent cells in the network. The size of a sector refers to the area covered by the antenna beams that provide service to the sector. The cellular network operator can change the size of a sector by adjusting the pointing angle in the elevation plane of the antenna beams generated by the linear arrays that provide coverage to the sector. The pointing angle of an antenna beam in the elevation plane is often referred to as the “tilt” angle. The term “downtilt” is typically used to refer to the situation where the tilt angle is negative so that the boresight pointing direction of the antenna beam is below the horizon. As the downtilt angle of an antenna beam is increased (i.e., as the tilt angle has an increasingly negative value), an axis that extends along the boresight of the antenna beam will point at a location on the ground that is closer and closer to the base station antenna, thereby reducing the size of the coverage area of the linear array. Thus, by changing the downtilt angle of an antenna beam that is generated by a linear array, it is possible to increase or decrease the coverage area served by the linear array.

In early cellular networks, the downtilt angle for the antenna beam generated by a linear array was adjusted by physically increasing or decreasing the amount that the base station antenna was tilted in the elevation (vertical) plane. In other words, a mechanical tilt was applied to the antenna that physically changed the pointing direction in the elevation plane of the antenna beams generated by the antenna. Most modern base station antennas, however, have arrays of radiating elements that have so-called remote electronic tilt (“RET”) capabilities. Base station antennas that have RET-enabled linear arrays include a control system that can receive instructions that are transmitted to the antenna from a remote location. When the base station antenna receives a control signal that seeks to adjust the downtilt angle of the antenna beams generated by a linear array thereof, the base station antenna adjusts a setting of an electromechanical phase shifter that is in the feed network for the linear array at issue, which acts to adjust the phases of the sub-components of an RF signal that are fed to respective subsets of the radiating elements in the linear array. The phase shifter is designed to adjust the extent of a phase progression that is applied to the sub-components of RF signal (i.e., increasing or decreasing the phase differences between the sub-components), which acts to electronically change the pointing direction of the antenna beam in the elevation plane. As the amount of the phase progression is increased, the amount of downtilt applied increases (i.e., the downtilt angle becomes increasingly negative), which acts to reduce how far the antenna beam will extend from the cell (thereby decreasing the size of the coverage area). A RET-enabled antenna typically includes one or more motors that drive mechanical linkage systems that are attached to the phase shifters so that the positions of moveable elements on the phase shifters may be changed to apply a desired amount of phase progression. Exemplary phase shifters are discussed in U.S. Pat. No. 7,907,096 to Timofeev, the disclosure of which is hereby incorporated herein in its entirety. U.S. Patent Publication No. 2020/0358170, the disclosure of which is also incorporated by reference herein, provides a detailed discussion of an entire RET system.

With the introduction of fifth generation (“5G”) cellular service, base station antennas now routinely include multi-column arrays of radiating elements that operate in conjunction with “beamforming” radios. The beamforming radio adjusts the magnitudes and phases of the sub-components of an RF signal that are passed to each column in an associated multi-column array in order to generate antenna beams that have narrower beamwidths in the azimuth plane. The narrower azimuth beamwidth increases the gain of the antenna beam, which allows the base station antenna to support much higher data rates. The amplitudes and phases of the sub-components of the RF signal may also be adjusted to steer the pointing direction of the antenna beam in the azimuth plane (i.e., the pointing direction in the azimuth plane where the antenna beam has peak gain) so that the narrowed antenna beam may be pointed at individual users or groups of users. The pointing direction of the antenna beam may be changed on a time slot-by-time slot basis of a time division duplexing (“TDD”) multiple access scheme so that the multi-column array may provide coverage over a full sector by providing coverage to different portions of the sector during different time slots. Thus, the 5G multi-column array generates high gain antenna beams that can support much higher data rate communications while still having the ability to provide coverage throughout a large coverage area such as a sector of a cell. These multi-column arrays may also operate using multi-input-multi-output (“MIMO”) communication techniques, which involve sub-dividing a baseband data stream into multiple sub-streams that are used to generate multiple RF signals that are transmitted through multiple different arrays of radiating elements. The multiple RF signals are recovered at the receiver and demodulated and decoded to recover the original data sub-streams, which are then recombined. MIMO transmission techniques may help overcome the negative effects of multipath fading, and may be particularly effective in urban environments where reflections may increase the level of decorrelation between the RF signals.

In many cases, the multi-column array of radiating elements and the beamforming radio are packaged together as a so-called “active antenna unit.” The active antenna unit may, for example, be mounted on an antenna tower as a standalone base station antenna (with integrated radio), or may be mounted on a so-called “passive” base station antenna that includes a plurality of 2G/3G/4G linear arrays of radiating elements to add 5G capabilities to the passive base station antenna.

### SUMMARY

Pursuant to embodiments of the present invention, base station antennas are provided that include a reflector, a RET actuator, an array of radiating elements, the radiating elements mounted to extend forwardly from the reflector, and a first metal tuning element that is at least partly positioned in front of the reflector. The first metal tuning element is configured to move when a remote electronic downtilt setting for the array of radiating elements is changed.

In some embodiments, the base station antenna may further include a phase shifter that is part of a feed network for the array of radiating elements and a mechanical linkage that converts movement of an output of the RET actuator to movement of a moveable element of the phase shifter.

In some embodiments, the first metal tuning element may be mounted on an element of the mechanical linkage. In some embodiments, the element of the mechanical linkage comprises a connecting rod that is mounted in front of the reflector. In other embodiments, the element of the mechanical linkage comprises a connecting rod that is mounted rearwardly of the reflector, and the first metal tuning element is connected to the connecting rod through an opening in the reflector.

In some embodiments, movement of the element of the mechanical linkage from a first position to a second position may change a position of the first metal tuning element.

In some embodiments, the radiating elements of the array of radiating elements are spaced apart from each other in a longitudinal direction of the antenna, the mechanical linkage includes a longitudinally-extending connecting rod, and the first metal tuning element is mounted on the connecting rod.

In some embodiments, the base station antenna may further comprise a second metal tuning element, wherein the second metal tuning element is mounted in a fixed position. In such embodiments, the first metal tuning element may be configured to cover at least a portion of the second metal tuning element when the first metal tuning element is moved from a first position to a second position. In some embodiments, the second metal tuning element may be configured to cover at least a portion of the first metal tuning element when the first metal tuning element is moved from a first position to a second position.

In some embodiments, the array of radiating elements may include a plurality of columns of radiating elements that extend in a longitudinal direction of the base station antenna, and the first metal tuning element may be configured to move in the longitudinal direction between first and second of the plurality of columns. In other embodiments, the first metal tuning element may be configured to move in the transverse direction between first and second of the plurality of columns.

In some embodiments, the array of radiating elements may include a plurality of columns of radiating elements that extend in a longitudinal direction of the base station antenna, and the first metal tuning element may comprise at least one isolation wall that extends in the longitudinal direction between first and second of the plurality of columns.

In some embodiments, the first metal tuning element may have a U-shaped cross-section.

In some embodiments, the first metal tuning element may include first and second isolation walls that each have a plurality of slots formed therein.

In some embodiments, movement of the metal tuning element may be configured to improve inter-band isolation performance of the multi-column array of radiating elements.

Pursuant to further embodiments of the present invention, base station antennas are provided that include a reflector, an array of radiating elements, the radiating elements mounted to extend forwardly from the reflector, and a metal tuning element that includes at least a first metal tuning piece and a second metal tuning piece that are at least partly positioned in front of the reflector, where the first metal tuning piece is configured to move relative to the second metal tuning piece.

In some embodiments, the first metal tuning piece is configured to move to cover an outer surface of the second metal tuning piece.

In some embodiments, the first metal tuning piece is configured to move so that the second metal tuning piece covers an outer surface of the first metal tuning piece.

In some embodiments, the base station antenna may further comprise a phase shifter that is part of a feed network for the array of radiating elements and a mechanical linkage that converts movement of an output of the RET actuator to movement of a moveable element of the phase shifter. In such embodiments, the first metal tuning piece may be mounted on an element of the mechanical linkage. In some embodiments, the element of the mechanical linkage comprises a connecting rod. The connecting rod may, for example, be mounted rearwardly of the reflector, and the first metal tuning piece is connected to the connecting rod through an opening in the reflector.

In some embodiments, movement of the element of the mechanical linkage from a first position to a second position may change a position of the first metal tuning element.

In some embodiments, the array of radiating elements extends in a longitudinal direction of the base station antenna, and the first metal tuning piece is configured to move in the longitudinal direction.

In some embodiments, movement of the metal tuning element is configured to improve inter-band isolation performance of the multi-column array of radiating elements.

Pursuant to still further embodiments of the present invention, base station antennas are provided that include a reflector, a RET actuator, a multi-column array of radiating elements, the radiating elements mounted to extend forwardly from the reflector, a plurality of phase shifters, and a plurality of connecting rods, where each connecting rod is configured to drive a respective moveable element on one or more of the phase shifters in response to movement of the RET actuator. At least some of the connecting rods have respective metal tuning elements mounted thereon.

In some embodiments, each connecting rod may extend between a pair of adjacent columns of radiating elements.

In some embodiments, the metal tuning element may comprise an isolation wall that extends between first and second of the columns of radiating elements.

In some embodiments, the metal tuning element may have a U-shaped cross-section.

In some embodiments, movement of the metal tuning element may improve inter-band isolation performance of the multi-column array of radiating elements.

Pursuant to additional embodiments of the present invention, a method of operating a base station antenna that includes both a metal tuning element and an electromechanical phase shifter, is provided. Pursuant to this method, both the metal tuning element and a moveable element of the phase shifter are physically moved at the same time.

Pursuant to yet additional embodiments of the present invention, base station antennas are provided that include a reflector, an array of radiating elements, the radiating elements mounted to extend forwardly from the reflector, an actuator, and a first metal tuning element that is at least partly positioned in front of the reflector. The first metal tuning element is configured to move between a first position and a second position in response to movement of the actuator.

In some embodiments, the metal tuning element comprises an isolation wall.

In some embodiments, the metal tuning element is electrically floating.

### BRIEF DESCRIPTION OF THE DRAWINGS

FIG. 1 is an exploded perspective view of a base station antenna in the form of an active antenna unit.

FIG. 2A is a schematic perspective view of an active antenna unit according to embodiments of the present invention (with its radome removed) that implements most of the RET mechanical linkage system on the front side of the reflector.

FIG. 2B is an enlarged front perspective view of the mechanical linkage system included in the active antenna unit of FIG. 2A.

FIG. 2C is an enlarged perspective view illustrating the connection between a slider of one of the connecting rods and the wipers of four phase shifters.

FIG. 2D is a partial front perspective view of a modified version of the active antenna unit of FIG. 2A that includes moveable metal tuning elements mounted on the RET mechanical linkage system to improve the inter-band isolation performance of the multi-column array.

FIG. 2E is an enlarged front perspective view of one of the metal tuning elements included in the active antenna unit of FIGS. 2A-2C.

FIGS. 3A-3D are front perspective views of example metal tuning elements according to further embodiments of the present invention.

FIGS. 4A-4C are schematic front perspective views of a portion of a base station antenna according to further embodiments of the present invention that illustrate how a pair of metal tuning elements may be used to apply an adjustable tuning effect.

FIG. 5 is a schematic perspective view that illustrates operation of a modified version of one of the moveable metal tuning elements included in the base station antenna of FIGS. 4A-4C.

FIGS. 6A-6B are front perspective views of a portion of a multi-column array of radiating elements included in a base station antenna according to still further embodiments of the present invention that illustrate how a metal tuning element may be moved in a transverse direction.

FIG. 7 is a front perspective view of a portion of a multi-column array of radiating elements included in a base station antenna according to additional embodiments of the present invention.

### DETAILED DESCRIPTION

Metal tuning elements are widely used in base station antennas to tune the performance of the antenna beams generated by the arrays of radiating elements thereof. Herein, the term “metal tuning element” refers to a structure that includes metal that is positioned to change one or more characteristics of a radiation pattern generated by a nearby array of radiating elements, where the structure is not connected to the feed network for the array (except, perhaps, to a common ground voltage). These metal tuning elements include for example, longitudinally and transversely extending isolation walls (also referred to as isolation fences), metal pins, metal columns having circular, T-shaped or cross-shaped cross-sections, etc. The metal tuning elements may be implemented, for example, using punched and/or bent sheet metal or printed circuit boards. These metal tuning elements may be designed to tune one or more performance parameters of the antenna beams generated by the arrays of radiating elements, including for example, azimuth beamwidth, elevation beamwidth, radiation pattern shape, cross-polarization discrimination, inter-band isolation, return loss, etc.

The impact of a metal tuning element on a particular performance parameter may vary as a function of the electronic downtilt angle of the generated antenna beams. As discussed above, most modern base station antennas include RET capabilities, and the impact that a metal tuning element has on certain performance parameters may vary based on the amount of electronic downtilt that is applied. The present application recognizes that the same physical movement that is used to adjust the phase shifters in a base station antenna in order to change the amount of electronic downtilt that is applied can also be used to adjust the positions of one or more metal tuning elements, so that the impact of the metal tuning elements can be more optimized to provide the effects that are needed at different amounts of applied electronic downtilt.

Pursuant to embodiments of the present invention, base station antennas are provided that include both RET capabilities and metal tuning elements that are used to tune a parameter of an array of radiating elements included in the base station antenna. The metal tuning elements are configured to move when a remote electronic downtilt setting for the array of radiating elements is changed. In some embodiments, the metal tuning elements may be mounted on moveable elements of a RET system of the base station antenna such as, for example, the connector rods that transfer movement of a RET actuator (e.g., a DC motor) to the moveable elements of one or more phase shifters (e.g., phase shifter wiper arms). In other embodiments, the metal tuning elements may be mounted on the reflector of the antenna (or on other elements that are not part of the RET system), and moveable elements of the RET system may directly or indirectly contact or otherwise interact with the metal tuning elements to change their position, orientation and/or tuning effect when the electronic downtilt setting for an array of the antenna is changed.

In some embodiments, base station antennas are provided that include a reflector, a RET actuator, an array of radiating elements that extend forwardly from the reflector, and a first metal tuning element that is at least partly positioned in front of the reflector. The first metal tuning element is configured to move when a remote electronic downtilt setting for the array of radiating elements is changed. The base station antenna may also include a phase shifter that is part of a feed network for the array of radiating elements and a mechanical linkage that converts movement of an output of the RET actuator to movement of a moveable element of the phase shifter. The first metal tuning element may, for example, be mounted on an element of the mechanical linkage such as a connecting rod. The connecting rod may be mounted in front of the reflector in some embodiments and behind the reflector in other embodiments. If mounted behind the reflector, the first metal tuning element may be connected to the connecting rod through an opening in the reflector.

Movement of the connecting rod from a first position to a second position will change a position of the first metal tuning element. In other words, movement of the connecting rod from a first position to a second position will result in a corresponding movement of the first metal tuning element from a third position to a fourth position.

Embodiments of the present invention will now be described in greater detail with reference to the attached drawings.

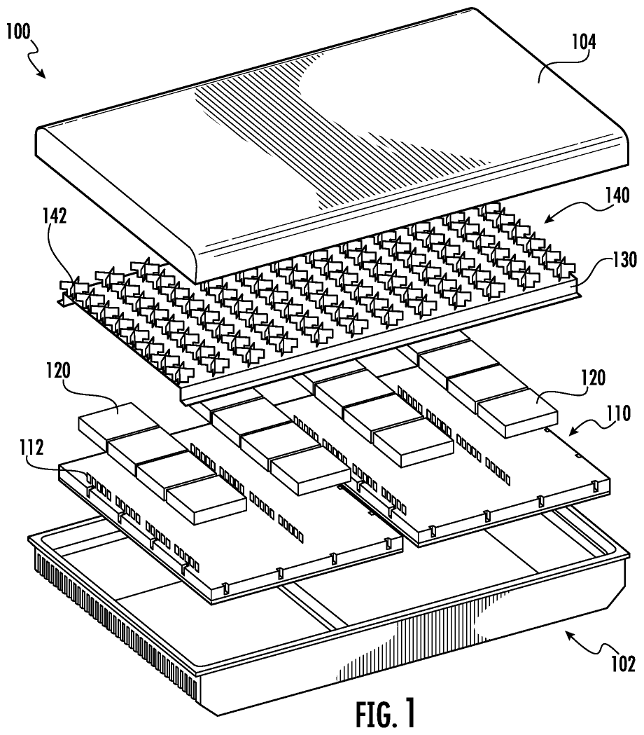

FIG. 1 is an exploded perspective view of an active antenna unit 100. As shown in FIG. 1, the active antenna unit 100 includes a beamforming radio 110, a plurality of filter units 120, a reflector 130, and a multi-column array 140 of radiating elements 142. The radiating elements 142 may be mounted on feedboard printed circuit boards (not shown) that are mounted on the forward face of the reflector 130. The radio 110 includes a plurality of radio ports 112 that connect to the filter units 120, allowing RF signals to be passed therebetween. The filter units 120 include RF ports (not shown) that connect through openings (not shown) in the reflector 130 to the feedboard printed circuit boards (not shown). These RF ports allow RF signals to be passed between the filter units 120 and the radiating elements 142. The radio 110, filter units 120, reflector 130, and multi-column array 140 are enclosed within a housing that includes a metal back housing 102 and a front radome 104.

As described above, multi-column arrays of radiating elements that operate in conjunction with a beamforming radio, such as multi-column array 140, have the capability to generate antenna beams having narrowed beamwidths in the azimuth plane. However, typically these arrays do not have the ability to steer the generated antenna beams in the elevation plane. As such, the multi-column arrays included in active antenna units often include RET systems that a cellular operator may use to electronically adjust the downtilt angle of the antenna beams generated by the multi-column array. This allows the cellular operator to remotely adjust how far the antenna beams will extend from the cell, thereby effectively changing the coverage area of the multi-column array.

There are often strict size restrictions for active antenna units. This is particularly true with respect to active antenna units that are mountable on passive base station antennas, as the combined antenna system must comply with local zoning ordinances and/or because smaller antennas experience less wind loading. As such, the area behind the reflector of many active antenna units is increasingly becoming tightly packed with electronic components such as RF filters and calibration circuits, and there may not be sufficient room to position the RET system behind the reflector. In such active antenna units, the phase shifters of the RET system may be implemented on the feedboard printed circuit boards (which are located on the front side of the reflector), and at least a portion of the mechanical linkage system (e.g., the connecting rods thereof) may also be mounted forwardly of the reflector, often in between the columns of radiating elements. Moreover, in order to further reduce the physical size of the active antenna unit, the spacing between the reflector and the radome, in some cases, may be as small as 30 mm. In such active antenna units, the connecting rods may substantially fill the space between adjacent columns of radiating elements, at least in the central portion of the multi-column array.

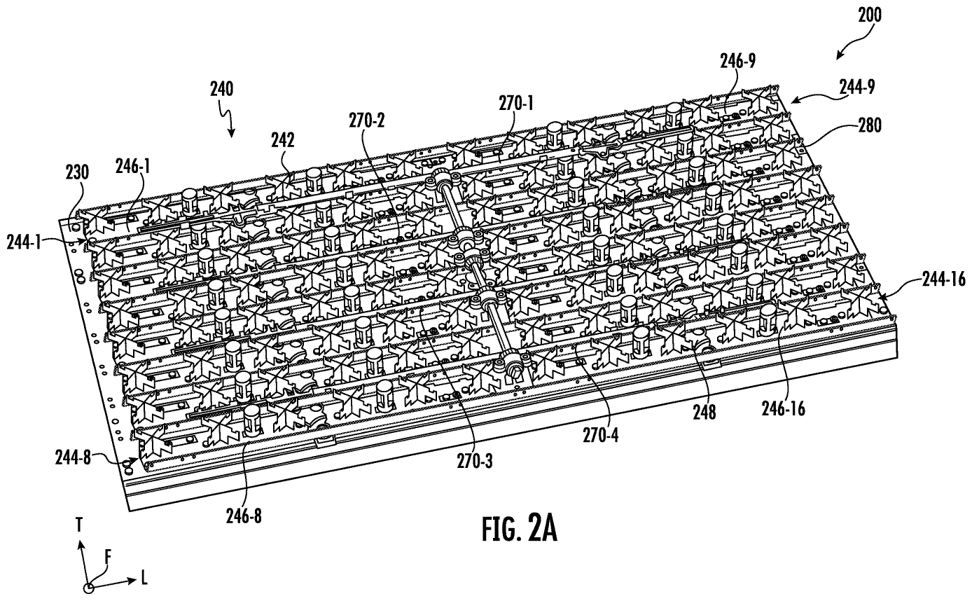

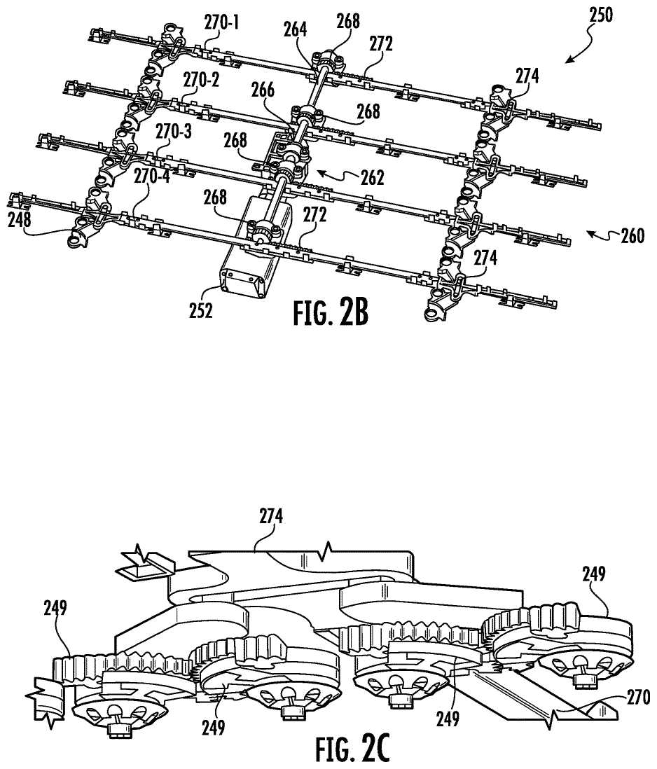

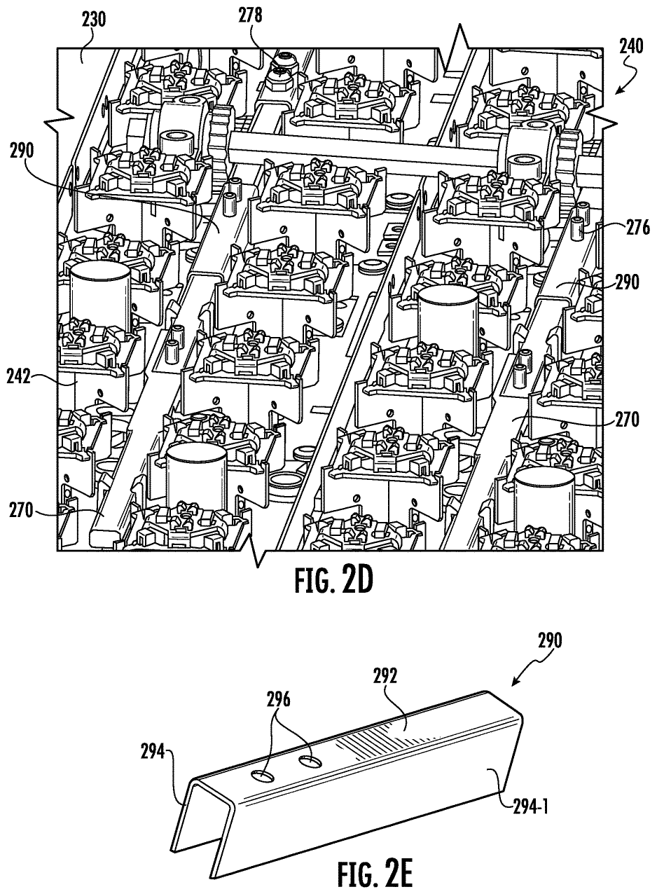

FIG. 2A is a schematic perspective view of an active antenna unit 200 according to embodiments of the present invention. The active antenna unit will include a front radome which is not shown in FIG. 2A so that various internal parts of the active antenna unit 200 can be seen. The active antenna unit 200 may be identical to the active antenna unit 100 discussed above, except that the active antenna unit 200 of FIG. 2A further includes a RET system and moveable tuning elements that have mounting positions that vary based on an amount of electronic downtilt applied by the RET system. It will be appreciated that in FIG. 2A the active antenna unit 200 is rotated nearly 90° from its orientation when mounted for use.

Referring to FIG. 2A, the active antenna unit 200 includes a multi-column array 240 of radiating elements 242 that are mounted to extend forwardly of a reflector 230. In the depicted embodiment, the array 240 includes sixteen columns 244-1 through 244-16 of radiating elements 242, which are arranged as two vertically stacked sets of eight columns 244. Note that only columns 244-1, 244-8, 244-9 and 244-16 are numbered in FIG. 2A to simplify the drawing. Columns 244-2 through 244-7 are arranged in numerical order between columns 244-1 and 244-8, and columns 244-10 through 244-15 are arranged in numerical order between columns 244-9 and 244-16.

The radiating elements 242 are dual-polarized radiating elements (e.g., slant 45°/+45° cross-dipole radiating elements), and hence each column 244 can simultaneously generate two antenna beams (one at each polarization). A beamforming radio (see FIG. 1) for active antenna unit 200 may thus include a total of thirty-two radio ports, so that a pair of radio ports are respectively coupled to each of the sixteen columns 244 of array 240 (a first radio port of the pair for a first polarization, and a second radio port of the pair for a second polarization different from the first polarization). Each column 244 of the array 240 extends in a longitudinal direction L of the active antenna unit 200. The columns 244 are spaced apart from each other in a transverse direction T of the active antenna unit 200 that is perpendicular to the longitudinal direction L. The radiating elements 242 extend forwardly from the reflector 230 in a forward direction F that is perpendicular to both the longitudinal direction L and the transverse direction T.

Still referring to FIG. 2A, it can be seen that the radiating elements 242 are mounted on a plurality of feedboard printed circuit boards 246-1 through 246-16. As with the columns 244, only feedboard printed circuit boards 246-1, 246-8, 246-9 and 246-16 are numbered in FIG. 2A.

Feedboard printed circuit boards 246-2 through 246-7 are arranged in numerical order between feedboard printed circuit boards 246-1 and 246-8, and feedboard printed circuit boards 246-10 through 246-15 are arranged in numerical order between feedboard printed circuit boards 246-9 and 246-16. The feedboard printed circuit boards 246 are mounted on the front surface of the reflector 230. Each feedboard printed circuit board 246 may be implemented as a microstrip printed circuit board that includes a dielectric substrate with a ground plane metal layer formed on a rear surface thereof and signal traces formed on the front surface of the dielectric substrate. A total of six radiating elements 242 are mounted on each feedboard printed circuit board 246, and hence each column 244 of the array 240 includes six radiating elements 242.

As is also shown in FIG. 2A, a plurality of longitudinally-extending isolation walls 280 are mounted to extend forwardly of the reflector 230. A total of nine isolation walls 280 are provided so that an isolation wall 280 is mounted on each side of all sixteen columns 244 of radiating elements 242. The isolation walls 280 may improve the inter-band isolation performance of the multi-column array 240, particularly when the antenna beams generated by the array 240 are scanned to large angles in the azimuth plane.

The active antenna unit 200 further includes a RET system 250 that allows for remote electronic adjustment of the downtilt angle of the antenna beams generated by the multi-column array 240. The RET system 250 is designed to apply the same amount of electronic downtilt to the antenna beams generated by each column 244 of the multi-column array 240. The RET system 250 may include a DC motor 252 (see FIG. 2B) that may, for example, be mounted behind the reflector 230, a mechanical linkage system 260 and a plurality of phase shifters 248.

FIG. 2B is a perspective view of the RET system 250 except for some portions of the phase shifters that are implemented in the feedboard printed circuit boards 246. As shown in FIG. 2B, the DC motor 252 is mounted to extend along the transverse direction T, and in this embodiment is designed to be positioned behind the reflector 230. A drive shaft of the DC motor 252 (not visible in the drawings) is coupled to a gear system 262 of the mechanical linkage system 260. The mechanical linkage system 260 further includes a transversely-extending rod 264 that includes a driven gear 266 and a plurality of drive gears 268 mounted thereon, and a plurality of connecting rods 270-1 through 270-4.

The phase shifters 248 are partially formed in the feedboard printed circuit boards 246, with a pair of phase shifters 248 formed in each feedboard printed circuit board 246. Only the wiper arms of each phase shifter are shown in FIG. 2B. The wiper arms are rotatably mounted above the remainder of the respective phase shifters 248 in the feedboard printed circuit boards 246. Each phase shifter 248 may be connected to a respective one of the ports of the beamforming radio. Each phase shifter 248 may be configured to split RF signals received from an associated radio port into a plurality of sub-components, and to apply a phase progression to the subcomponents that imparts a desired amount of electronic downtilt to the antenna beam generated by the column 244 of six radiating elements 242. Since operation of wiper arm phase shifters are well understood in the art (see, e.g., the above-referenced patent to Timofeev), further description of the phase shifters 248 will not be provided.

Still referring to FIG. 2B, the gear system 262 couples the output shaft of the DC motor 252 to the driven gear 266 on the transversely-extending rod 264. The gear system 262 transfers rotation of the output shaft of the DC motor 252 into rotation of the driven gear 266. The driven gear 266 is fixedly mounted on the transversely-extending rod 264 so that rotation of the driven gear 266 results in rotation of the transversely-extending rod 264. The drive gears 268 are fixedly mounted on the transversely-extending rod 264 so that rotation of the transversely-extending rod 264 results in rotation of the drive gears 268.

Each connecting rod 270 extends in the longitudinal direction L of the active antenna unit 200. The connecting rods 270 typically will not extend the full length of the reflector 230.

Each connecting rod 270 has a rack 272 (i.e., a linear gear) mounted or formed thereon. Each rack 272 is aligned to mate with a respective one of the driven gears 268 so that rotation of the driven gears 268 results in linear movement of the racks 272, which results in linear movement of the connecting rods 270 in the longitudinal direction L. As can best be seen in FIG. 2A, each connecting rod 270 extends in between two pairs of the columns 244 of array 240. For example, connecting rod 270-1 extends between columns 244-1 and 244-2 and in between columns 244-9 and 244-10. Each connecting rod 270 also includes a pair of sliders 274 that are provided near either end of the respective connecting rods 270. For example, the first slider 274 on connecting rod 270-1 captures a first pin that is on a wiper arm of one of the phase shifters 248 in the first column 244-1 and captures a second pin that is on a wiper arm of one of the phase shifters 248 in the second column 244-2. Similarly, the second slider 274 on connecting rod 270-1 captures a first pin that is on a wiper arm of one of the phase shifters 248 in the ninth column 244-9 and captures a second pin that is on a wiper arm of one of the phase shifters 248 in the tenth column 244-10. As a result, linear movement of the connecting rod 270-1 is transferred by the two sliders 274 thereon into rotational movement of a wiper arm of one of the two phase shifters 248 on each of four feedboard printed circuit boards 246-1, 246-2, 246-9, 246-10. As can be seen in FIG. 2C, which is an enlarged view of one of the sliders on connecting rod 270-1 and the wiper arms 249 of the four phase shifters 248 on feed board printed circuit boards 246-1, 246-2, the wiper arms on each feedboard printed circuit board 246 are geared so that rotation of the wiper arm 249 of the first phase shifter 246 on a feedboard printed circuit board 246 results in rotation of the wiper arm 249 of the second phase shifter 248 on the feedboard printed circuit board 246. Thus, it can be seen that linear movement of connecting rod 270-1 results in rotation of the wiper arms of the eight phase shifters 246 formed on feedboard printed circuit boards 246-1, 246-2, 246-9, 246-10. Connecting rods 270-2 through 270-4 operate in the exact same manner so that linear movement of connecting rods 270-2 through 270-4 results in rotation of the wiper arms of the remaining twenty-four phase shifters 246. Thus, the mechanical linkage system 260 includes a total of four connecting rods 270 that are used to adjust the thirty-two phase shifters 248 associated with multi-column array 240.

The DC motor 252 is mounted behind the reflector 230. However, filter units, calibration boards and the beamforming radio (see FIG. 1) may substantially fill the remaining room behind the reflector 230. As a result, the transversely-extending rod 264, the driven gear 266, the drive gears 268 and the connecting rods 270 are all mounted forwardly of the reflector, and the phase shifters 248 are likewise mounted forwardly of the reflector 230 on the feedboard printed circuit boards 246. The gear system 262 extends through the reflector 230.

As discussed above, pursuant to embodiments of the present invention, moveable metal tuning units may be added to base station antennas to improve the performance thereof. FIG. 2D is a partial perspective view of an upgraded version of the active antenna unit 200 (labelled active antenna unit 200′ in FIG. 2D) that includes moveable metal tuning units 280. The moveable metal tuning units 280 are mounted on the connector rods 270, with two moveable metal tuning units 280 mounted on each connecting rod. Since FIG. 2D is an enlarged view that only illustrates a portion of the active antenna array, only three of the moveable metal tuning units 280 are visible in FIG. 2D. It will be appreciated that the moveable metal tuning units may be mounted at the same two locations on each connecting rod 270. It will also be appreciated that the active antenna unit 200′ of FIG. 2D may be identical to the active antenna unit 200 of FIG. 2A except as discussed below.

As discussed above, the active antenna unit 200 includes fixed isolation walls 280 that are mounted to extend forwardly from the reflector 230. The isolation walls 280 help improve the inter-band isolation performance of active antenna unit 200. Unfortunately, however, in some active antenna units, such as active antenna unit 200′ of FIG. 2D, the spacing between the reflector 230 and the radome (not shown) may be very small. For example, this spacing may be less than 30 mm. When this spacing is small, there may not be room to stack the isolation walls 280 and the connector rods 270 in the forward direction F, as is done with active antenna unit 200 of FIG. 2A.

In such antennas, four of the fixed isolation walls 280 are removed to provide room to mount the connecting rods 270 just forwardly of the reflector 230. Removing the four isolation walls 280 tends to degrade the inter-band isolation performance of the array 240.

The inter-band isolation performance of an array is a measure of the isolation between the different columns of radiating elements of the array. The inter-band isolation performance of a multi-column array may be measured by applying an RF signal to a first RF port that is connected to the first polarization radiators of a first column of the array and measuring the amount of RF energy received at a second port that is connected to the first polarization radiators of an adjacent column of the array. Cellular operators may require minimum inter-band isolation performance levels as poor inter-band isolation may require increased filtering and/or may degrade the performance of the cellular system.

The inter-band isolation performance of an array may depend on a variety of factors, including the type of dipole radiators included in the radiating elements and the environment surrounding the radiating elements such as the size of the underlying reflector, nearby radiating elements that operate in different frequency bands, the radome, and various other features of the base station antenna. In order to decrease the size of an active antenna unit, the columns of radiating elements are often positioned in very close proximity. This close spacing of the columns tends to degrade the inter-band isolation performance of the multi-column array. This is particularly true when the antenna beams generated by the multi-column array are electronically scanned in the azimuth plane (i.e., the boresight pointing direction is scanned in the azimuth plane).

The above discussed metal tuning elements in the form of isolation walls 280 are provided to improve the inter-band isolation performance of the multi-column array 240. In particular, the isolation walls 280 can reduce coupling between the radiating elements 242 of adjacent columns 244, particularly at larger azimuth scanning angles, where the inter-band isolation performance may be the worst. Moreover, the isolation walls 280 may also advantageously reduce the azimuth beamwidth of the antenna beams generated by the columns 244 of the array 240 that are adjacent the isolation wall 280.

However, as discussed above, the connecting rods 270 are mounted in locations where isolation walls 280 are typically mounted, and hence isolation walls 280 cannot be provided between all pairs of adjacent columns 244 of radiating elements 242. As a result, the multi-column array 240 exhibits worst-case inter-band isolation performance of −17 dB, which is somewhat higher than desired.

In order to improve the inter-band isolation performance of array 240, metal tuning elements 290 are mounted on each connector rod 270. Since the connecting rods are moveable (i.e., the positions of the connecting rods 270 change when the electronic downtilt angle setting for the array 240 is changed), the metal tuning elements 290 are thus moveable tuning elements 290. In some embodiments, the moveable tuning elements 290 may be implemented as isolation wall structures having a generally U-shaped cross-section that are mounted to cover front and side portions of the connecting rods 270. In other embodiments, the moveable tuning elements 290 may be planar sheets that are mounted on side surfaces and/or the front surface of the connecting rods 270. In still other embodiments, the metal tuning elements may comprise pins, columns or other shaped metal elements. The moveable tuning elements 290 may be formed of sheet metal, printed circuit boards, metal rods or pins and the like in example embodiments. The moveable tuning elements 290 may improve the inter-band isolation performance of the array and may also advantageously narrow the azimuth beamwidths of the antenna beams generated by each column 244 of radiating elements 242 in array 240.

FIG. 2E is an enlarged, front perspective view of one of the moveable metal tuning elements 290 included in active antenna unit 200′ of FIG. 2D. As shown in FIG. 2E, the moveable metal tuning element 290 comprises a three-sided piece of metal that has a front surface 292 and a pair of sidewalls 294-1, 294-2 that extend rearwardly from the front surface 292 so that the moveable metal tuning element 290 has a generally U-shaped transverse cross-section. The front surface 292 includes a pair of circular openings 296. The moveable metal tuning element 290 shown in FIG. 2E may be conveniently formed from stamped and bent sheet metal, although it can be formed in other ways.

Referring again to FIG. 2D, it can be seen that each circular opening 296 on the moveable tuning elements 290 receives a respective externally threaded pin 276 (the threads are not shown in FIG. 2D) that extends forwardly from the connector rod 270. Mounting the moveable metal tuning elements 290 on the connector rods 270 using the externally-threaded pins 276 ensures that the moveable metal tuning elements 290 are mounted in the correct location. Once the moveable metal tuning elements 290 have been mounted on the externally-threaded pins 276, corresponding nuts 278 may be threaded onto the pins 276 to securely fix the moveable metal tuning elements 290 to the connector rods 270. In FIG. 2D, the nuts 278 are only shown on some of the pins 276 to better illustrate how the moveable metal tuning elements 290 are mounted on the connector rods 270.

The moveable metal tuning elements 290 may function as isolation walls that reduce coupling between radiating elements 242 in adjacent columns 244 of array 240 that do not have an isolation wall 280 separating the columns 244. However, because the moveable metal tuning elements 290 are mounted on the connector rods 270, the sidewalls 294 are positioned much closer to the radiating elements 242 in the adjacent columns 244 than are the isolation walls 280, since the isolation walls 280 run longitudinally midway between two adjacent columns 244, whereas the sidewalls 294 of the moveable metal tuning elements 290 are positioned closer to the respective columns 244. As a result, the moveable metal tuning elements 290 may have a significantly greater narrowing effect on the azimuth beamwidth of the antenna beams generated by the columns 244 that are adjacent the moveable metal tuning elements 290. In order to ensure that the azimuth beamwidth is not reduced too much, the moveable metal tuning elements 290 only extend a relatively short distance in the longitudinal direction L, and do not extend the full length of the array 240 like the isolation walls 280. This allows the moveable metal tuning elements 290 to improve the inter-band isolation performance and also improve the azimuth beamwidth performance, without overly narrowing the azimuth beamwidth.

Simulation results show that adding the moveable metal tuning elements 290 to the array 240 may improve the worst case inter-band isolation from −17 dB to −20 dB while also improving the azimuth beamwidth.

Thus, as shown in FIG. 2D, the base station antenna 200 includes a reflector 230, a RET system 250 and a multi-column array 240 of radiating elements 242. Each radiating element 242 extends forwardly from the reflector 230. A first metal tuning element 290 is positioned in front of the reflector 230, and is configured to move when a RET setting for the array 240 of radiating elements 242 is changed. The first metal tuning element 290 is mounted on a longitudinally-extending connector rod 270 of the mechanical linkage system 260, where the connector rod 270 is mounted forwardly of the reflector 230.

Since the metal tuning elements 290 are mounted on the connector rods 270, the position of the metal tuning elements 290 will change each time the electronic downtilt setting for the array 240 is modified. In some embodiments, the size, shape, number and/or positions of the moveable metal tuning elements 290 may be selected so that the performance of array 240 may be further improved. For example, in other embodiments, each connecting rod may include more or less than two moveable metal tuning elements mounted thereon, the sizes and/or shapes of the moveable metal tuning elements may differ from that shown in FIGS. 2D-2E (and not all moveable metal tuning elements 290 need have the same shape or size), and the positions of the moveable metal tuning elements may also be varied (in any direction).

It will also be appreciated that the inter-band isolation performance of a multi-column beamforming array such as array 240 typically varies based on the amount of electronic downtilt applied. For example, the inter-band isolation may tend to be worse (higher) in some cases at relatively smaller electronic downtilt angle settings than at relatively larger electronic downtilt angle settings. The metal tuning elements 290 may have the greatest impact on the inter-band isolation when the metal tuning elements 290 are directly between two radiating elements 242.

Thus, in some embodiments, the moveable metal tuning elements 290 may be positioned on the connector rods 270 so that they are directly in between two adjacent radiating elements 242 (in the transverse direction T) when the applied electronic downtilt angle is relatively small, but are in between the open spaces between adjacent radiating elements 242 in the columns 244 when the applied electronic downtilt angle is relatively large. In this fashion, the moveable metal tuning elements 290 may have a larger impact on the inter-band isolation when the array 240 is set for smaller electronic downtilt angles than when it is set for larger electronic downtilt angles, thereby improving the performance of the array 240 over a wide range of applied electronic downtilt angle settings. This would not be possible in some cases if the metal tuning elements 290 were not moveable.

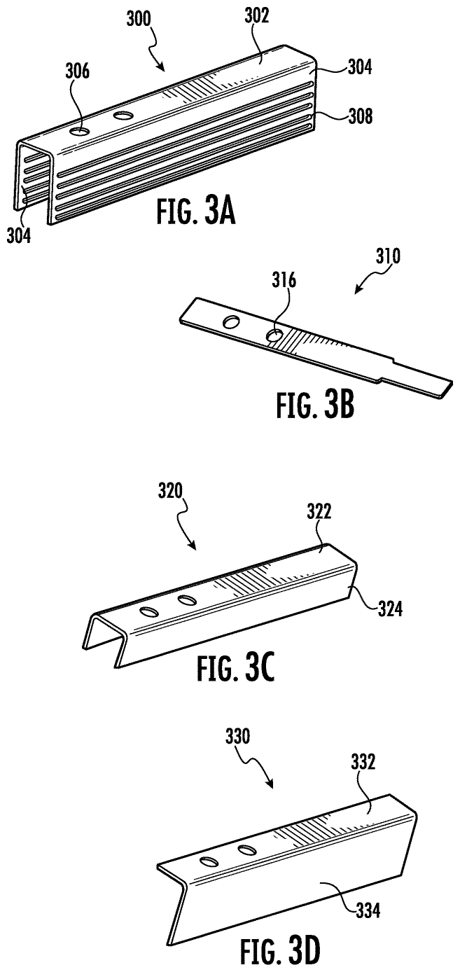

FIGS. 3A-3D illustrate example moveable metal tuning elements 290 according to further embodiments of the present invention. It will be appreciated that the metal tuning elements illustrated in these figures are just examples that will help the skilled artisan understand different ways that the present invention can be implemented, and that a wide variety of other metal tuning element designs may be used.

Referring first to FIG. 3A, a metal tuning element 300 is shown that is very similar to moveable metal tuning element 290 of FIG. 2D. In particular moveable metal tuning element 300 has a front wall 302 with a pair of circular openings 306 therein, and a pair of rearwardly extending sidewalls 304. In addition, and in contrast to the moveable metal tuning element 290 of FIG. 2D, each sidewall 304 of moveable metal tuning element 300 of FIG. 3A further includes a plurality of longitudinally-extending slots 308. The slots 308 may help further control the azimuth beamwidth.

Referring to FIG. 3B, a simpler moveable metal tuning element 310 is illustrated that comprises a planar sheet of metal that has a pair of circular openings 316 formed therein. The moveable metal tuning element 310 may alternatively be implemented using a printed circuit board. The moveable metal tuning element 310 may be mounted on the front surface of a connector rod 270 so that the moveable metal tuning element 310 is parallel to the reflector 230 of the multi-column array 240. The moveable metal tuning element 310 may be used, for example, in situations where there is not sufficient clearance on the sides of the connector rod 270 to allow for sidewalls on the moveable metal tuning element.

Referring to FIG. 3C, a moveable metal tuning element 320 is illustrated that again is similar to moveable metal tuning element 290, except that the sidewalls 324 of moveable metal tuning element 320 do not extend as far rearwardly. FIG. 3D illustrates yet another moveable metal tuning element 330 that includes a front wall 332 and a single sidewall 334.

While the moveable metal tuning elements discussed above can all be implemented from sheet metal, it will be appreciated that embodiments of the present invention are not limited thereto. For example, in other embodiments, die cast moveable metal tuning elements may be used, or metallization may be selectively formed or deposited on the connector rods 270 (e.g., by laser direct sintering) to provide moveable metal tuning elements.

The discussion above illustrates how the moveable metal tuning elements according to embodiments of the present invention can improve the inter-band isolation and azimuth beamwidth performance of a multi-column array of radiating elements. It will be appreciated, however, that the moveable metal tuning elements according to embodiments of the present invention may be used in a wide variety of base station antennas and/or may improve a wide variety of different performance parameters associated with the radiating element arrays of such antennas.

In particular, there are a number of performance parameters of antenna beams that tend to vary as a function of the applied electronic downtilt angle setting including, among other things, azimuth beamwidth, elevation beamwidth, radiation pattern shape, cross-polarization discrimination, inter-band isolation, and return loss. When conventional tuning techniques are used, tuning elements are added to the base station antenna that address the “worst case” for the performance parameter at issue, as cellular network operators typically are most interested in ensuring that a base station antenna always exhibits minimum specified performance levels.

However, when tuning elements are added to improve a worst case performance parameter, the tuning elements often degrade other aspects of the performance of the antenna (e.g., the performance at other electronic downtilt angles, electronic scanning angles, frequencies, etc.). Thus the tradeoffs between performance under different operating conditions often limits how much metal tuning elements may be used to improve the performance of a radiating element array.

Since the metal tuning elements according to embodiments of the present invention are moveable, they may be designed to provide a different tuning effect under different operating conditions. This may be very effective in addressing differences in performance that may occur due to an array of radiating elements being set for different electronic downtilt angles, as the moveable metal tuning elements may be designed to have more or less impact on the antenna beams as a function of the amount of electronic downtilt applied.

As discussed above, in some embodiments, the impact that the moveable metal tuning elements according to embodiments of the present invention have on the performance of an array may vary based on the longitudinal position of the moveable metal tuning elements. In particular, the antenna may be designed so that over a first range of electronic downtilt settings the moveable metal tuning elements may be close to the radiating elements (where they generally tend to have a large tuning effect) while at a second range of electronic downtilt settings the moveable metal tuning elements may be spaced farther apart from the radiating elements (where they generally tend to have a smaller tuning effect). It will be appreciated, however, that embodiments of the present invention are not limited to providing a variable tuning effect in this manner.

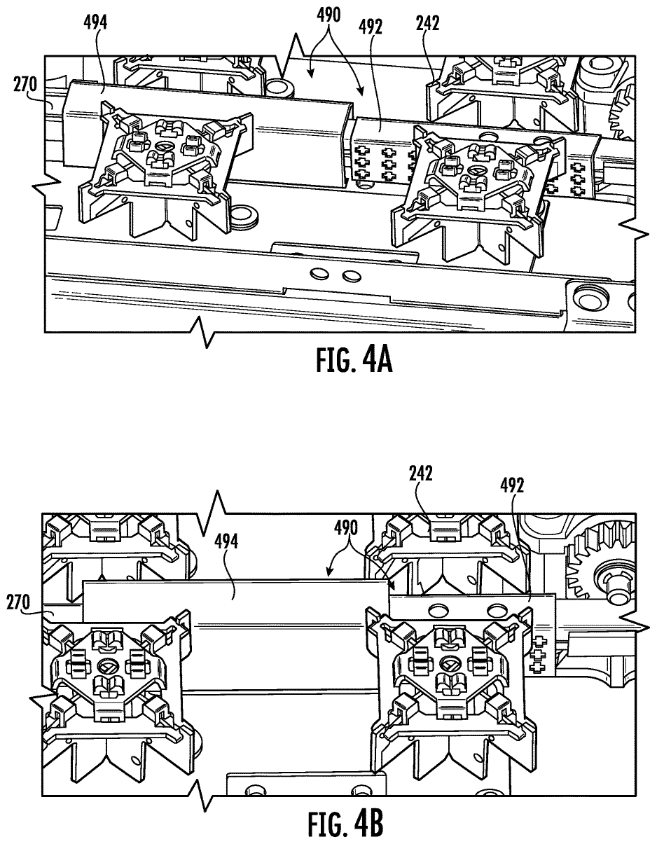

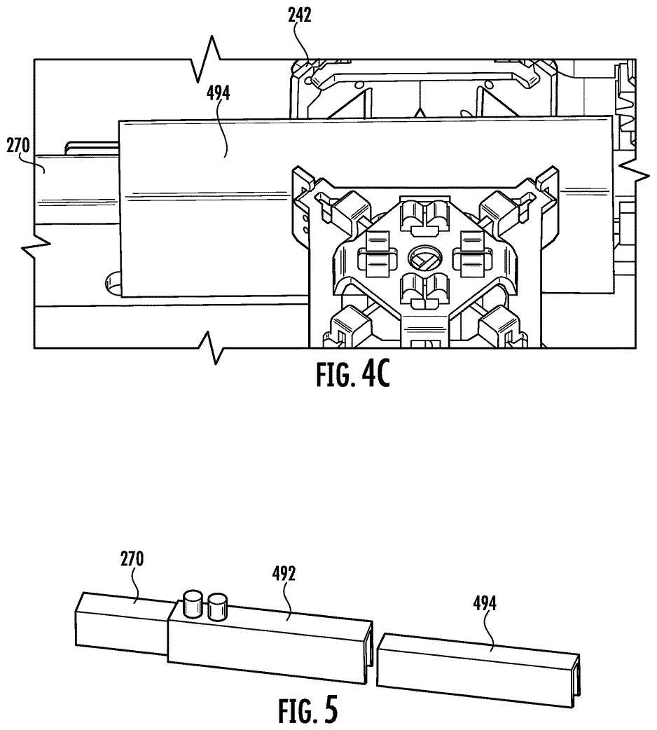

For example, FIGS. 4A-4C are greatly enlarged, front perspective views of a modified version of active antenna unit 200′ that is labeled active antenna unit 400. Active unit 400 may be identical to active antenna unit 200′ except that active antenna unit 400 includes moveable metal tuning element systems 490 that have effective sizes that differ based on an electronic downtilt setting for the antenna array 240 of the active antenna unit 400. FIGS. 4A-4C only illustrate one of the moveable metal tuning element systems 490 of active antenna unit 400, a portion of a connector rod 270 on which part of the moveable metal tuning element system 490 is mounted, and four of the radiating elements 242 that are directly adjacent the moveable metal tuning element system 490.

As shown in FIGS. 4A-4C, the moveable metal tuning element system 490 includes a first moveable metal tuning element 492 and a second metal tuning element 494. The second metal tuning element 494 may be fixed or moveable, and is moveable with respect to the first moveable metal tuning element 492. In the depicted embodiment, the second metal tuning element 494 is fixed to the reflector 230. The first moveable metal tuning element 492 is configured so that it can be moved so that at least portions of the second metal tuning element 494 may be disposed between the first moveable metal tuning element 492 and radiating elements 242 of the array 240. In the depicted embodiment, moveable metal tuning element 492 is similar to moveable metal tuning element 290, but further includes an array of cut-out areas in each sidewall where the metal is removed to provide a different tuning effect. Metal tuning element 494 has the same shape as moveable metal tuning element 290, but has a slightly larger width in the transverse direction T and height in the forward direction F so that moveable metal tuning element 492 may be received within an interior of metal tuning element 494.

As shown in FIGS. 4A-4C, a moveable metal tuning element system 490 is partially mounted on the connecting rod 270. In particular, the first moveable tuning element 492 is mounted on the connector rod 270, while the second tuning element 494 is fixedly mounted adjacent the first moveable tuning element 492. In an example embodiment, each connecting rod 270 includes two moveable metal tuning elements mounted thereon. FIGS. 4A-4C show how the position of moveable metal tuning element 492 changes as the electronic downtilt setting for array 240 is changed.

As shown in FIG. 4A, when the array 240 is at a first electronic downtilt setting, the first moveable metal tuning element 492 is spaced apart from the second metal tuning element 494. When the array 240 is at this first electronic downtilt setting, both the first moveable metal tuning element 492 and the second metal tuning element 494 may act as tuning elements that tune a performance parameter of the array 240. As shown in FIG. 4B, when the array 240 is at a second (different) electronic downtilt setting, the first moveable metal tuning element 492 may at least partly overlap with the second metal tuning element 494 so that at least a portion of the second metal tuning element 494 is disposed between the first moveable metal tuning element 492 and adjacent radiating elements 242 of the array 240. In this second position, only a portion of the first moveable metal tuning element 492 will act as a tuning element that tunes a performance parameter of the array 240. Thus, in the second position, since part of the first moveable metal tuning element 492 is “hidden” by the second metal tuning element 494, the first moveable metal tuning element 492 will have less of an effect on tuning. As shown in FIG. 4C, when the array 240 is at a third (different) electronic downtilt setting, the first moveable metal tuning element 492 may be completely hidden behind the second metal tuning element 494. In this third position, only the second metal tuning element 494 will act as a tuning element that tunes a performance parameter of the array 240. Thus, in the third position, the moveable metal tuning element system 490 will have even less of an effect on tuning. Thus FIGS. 4A-4C illustrate how the effective shape of a metal tuning element may be varied based on an electronic downtilt setting for the array 240.

In the above example, a width in the transverse direction of the first moveable metal tuning element 492 is made smaller than a width in the transverse direction of the second metal tuning element 494 so that the first moveable metal tuning element 492 can be moved within an interior of the second metal tuning element 494 so as to be shielded by the second metal tuning element 494. It will be appreciated that embodiments of the present invention are not limited thereto. For example, in other embodiments, a width in the transverse direction of the second metal tuning element 494 may be made smaller than a width in the transverse direction of the first moveable metal tuning element 492 so that the first moveable metal tuning element 492 can be moved to cover the second metal tuning element 494. For example, FIG. 5 illustrates such an embodiment in which a first moveable metal tuning element 492 having a first transverse width is mounted to extend from an end of a connector rod and a second metal tuning element 494 having a second, smaller, transverse width is mounted adjacent to and longitudinally aligned with the first moveable metal tuning element 492.

Thus, as shown in FIGS. 4A-4C and 5, the base station antenna 400 includes a reflector 230 and an array 240 of radiating elements 242, where each radiating element 242 is mounted to extend forwardly from the reflector 230. The antenna 400 further includes a metal tuning element system 490 that includes at least a first metal tuning piece 492 and a second metal tuning piece 492 that are at least partly positioned in front of the reflector 230, and where the first metal tuning piece 492 is configured to move relative to the second metal tuning piece 494. In some embodiments, the first metal tuning piece 492 is configured to move to cover an outer surface of the second metal tuning piece 494. In other embodiments, the first metal tuning piece 492 is configured to move so that the second metal tuning piece 494 covers an outer surface of the first metal tuning piece 492. In some embodiments, the first metal tuning piece 492 may be mounted on an element of a RET mechanical linkage system of the base station antenna 400, such as, for example, a connector rod of the mechanical linkage.

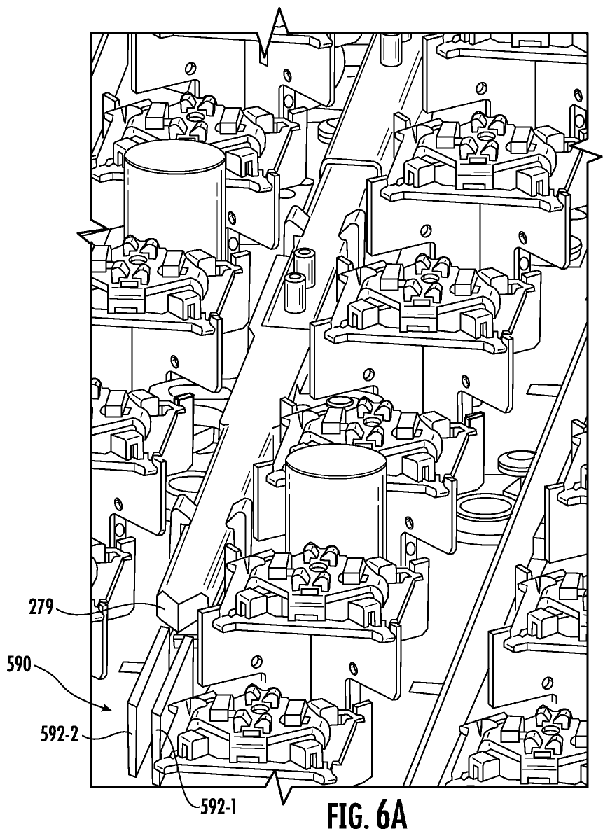

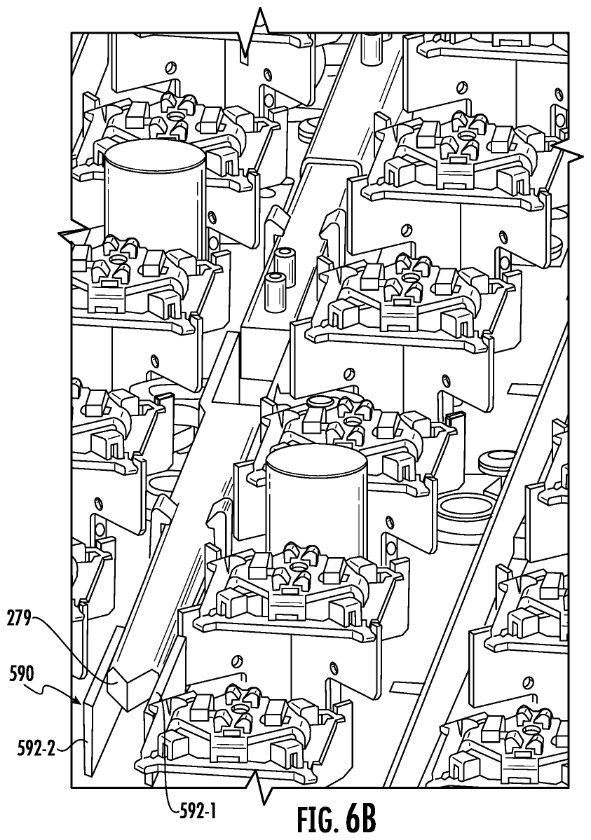

In the above described embodiments, the moveable tuning elements move along the longitudinal direction L of the active antenna units in which they are mounted. It will be appreciated that embodiments of the present invention are not limited thereto. FIGS. 6A-6B illustrate another modified version of active antenna unit 200′ that is labeled active antenna unit 500. Active antenna unit 500 may be identical to active antenna unit 200′ except that active antenna unit 500 includes moveable metal tuning elements 590 that move in the transverse direction T as opposed to in the longitudinal direction L.

As shown in FIGS. 6A-6B, in this embodiment, the moveable metal tuning elements 590 are not mounted on the connector rods 270, but extend are mounted to extend forwardly from the reflector 230. The moveable metal tuning elements 590 are longitudinally aligned with the connector rods 270. The lower end of each connector rod 270 includes a double-beveled surface 279. Each moveable metal tuning element 590 is configured as first and seconds longitudinally-extending metal walls 592-1, 592-2 that are each spring biased to be positioned close to a longitudinal axis that extends halfway between first and second of the columns 244 of radiating elements 242, as shown in FIG. 5A. As shown in FIG. 6B, when the connector rod 270 is moved a sufficient distance (in response to a command changing the electronic downtilt setting for array 240), the beveled surfaces on the connector rod 270 move in between the first and seconds longitudinally-extending metal walls 592-1, 592-2 and force the two walls 592-1, 592-2 outwardly in the transverse direction so that each wall 592 is moved closer to a respective one of the first and second columns 244 of radiating elements 242. Thus, the example of FIGS. 6A-6B illustrate that the moveable tuning elements according to embodiments of the present invention may move in any appropriate direction to achieve a desired variable tuning effect.

In the above examples, most of the RET system for the array 240 was mounted forwardly of the reflector 230, and the array 240 is a multi-column array 240 of radiating elements 242. It will also be appreciated that embodiments of the present invention are not limited thereto.

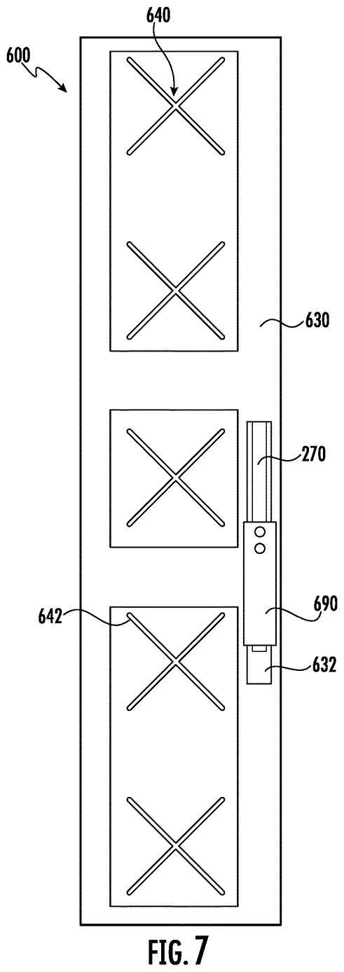

FIG. 7 illustrates a base station antenna 600 according to further embodiments of the present invention that includes moveable metal tuning elements 690. The base station antenna 600 is a passive base station antenna that includes one or more linear arrays 640 of radiating elements 642 that operate, for example, under 3G or 4G network protocols. A first linear array 640 of low-band radiating elements 642 is shown in FIG. 7. The radiating elements 642 are mounted to extend forwardly from respective feedboard printed circuit boards 646, with one or two radiating elements 642 mounted on each feedboard printed circuit board 646. The base station antenna 600 includes a RET system for the first linear array 640. The RET system is located on the rear side of reflector 630 and hence is mostly not visible in FIG. 6. The RET system may include, for example, a DC motor, a mechanical linkage system that includes at least one connector rod 270 and a pair of phase shifters, all of which are positioned behind the reflector 630. Coaxial cables extend between the outputs of the phase shifters and the feedboard printed circuit boards 646 that pass RF signals between the dipole radiators of the radiating elements 642 and the phase shifters.

As shown in FIG. 7, an opening in the form of a longitudinally-extending slot 632 is provided in reflector 630. The slot 632 may be positioned above connector rod 270 of RET system 650. The moveable metal tuning element 690 is directly or indirectly mounted on the connector rod to extend forwardly of the reflector 630. The moveable metal tuning element 690 may be any of the metal tuning elements disclosed herein. The embodiment of FIG. 7 illustrates that the RET system may be primarily or completely implemented behind the reflector of the antenna, that the reflector may include openings and the metal tuning elements may be connected to elements of the RET system through these openings. The embodiment of FIG. 7 also illustrates that the techniques disclosed herein may be used in both active and passive base station antennas.

While the metal tuning elements have primarily been illustrated above as being isolation walls, it will be appreciated that embodiments of the present invention are not limited thereto. In other embodiments, the metal tuning elements may comprise isolation pins, frequency selective isolation surfaces, or any other metal tuning element. The metal tuning elements may be implemented using a wide variety of different materials such as sheet metal, printed circuit boards and metal or metal coated pins.

While the present invention has primarily been described above with reference to moveable metal tuning elements that are mounted on elements of a RET system, it will be appreciated that embodiments of the present invention are not limited thereto. For example, in other embodiments moveable metal tuning elements may be provided that can be operated independently of the RET system of a base station antenna.

For example, as is known in the art, many base station antennas include so-called multi-RET actuators which refer to systems that typically include one or two DC motors that can be selectively connected to a much larger number of connector rods (e.g., six to twelve connector rods) in order to independently adjust the setting (position) of the connector rods. U.S. Patent Publication No. 2017/0365923, the contents of which are incorporated herein by reference, illustrates a number of example multi-RET actuators. In many cases, a base station antenna that includes such a multi-RET actuator may have unused connector rods. Moveable metal tuning elements could be mounted on these unused connector rods.

One possible application for the above-described moveable metal tuning elements would be for base station antennas that are capable of operating across a wide frequency range (e.g., the 1427-2690 MHz frequency band). Many of the performance parameters associated with the antenna beams generated by an array may vary as a function of frequency. For example, azimuth beamwidth almost always varies as a function of frequency. Moreover, when a cellular network operator deploys the arrays of the base station antenna the base station antenna will be connected to radios that typically only transmit and receive signals in a very small portion of the wide frequency range (e.g., a 40 MHz sub-band). When the base station antenna is deployed, the cellular network operator may, for example, cause the antenna to adjust the positions of moveable metal tuning elements that are mounted on the extra connector rods so that the moveable metal tuning elements are positioned in locations that improve a performance parameter of the antenna beams generated by at least one of the arrays of the antenna when the at least one array operates at a particular frequency band. In this fashion, the performance of the antenna may be adjusted to compensate for changes in performance that occur as a function of frequency. Thus, it will be appreciated that the techniques disclosed herein may be used to compensate for any parameter (e.g., electronic downtilt angle, operating frequency, etc.) that has a variable impact on the generated antenna beams. It will likewise be appreciated that the moveable metal tuning elements may be moved using the RET system for a base station antenna or by one or more separate actuators that are not part of the RET system.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

1. A base station antenna, comprising:
a reflector;
remote electronic tilt (“RET”) actuator;
an array of radiating elements, the radiating elements mounted to extend forwardly from the reflector; and
a first metal tuning element that is at least partly positioned in front of the reflector,
wherein the first metal tuning element is configured to move when a remote electronic downtilt setting for the array of radiating elements is changed.

2. The base station antenna of claim 1, further comprising:
a phase shifter that is part of a feed network for the array of radiating elements; and
a mechanical linkage that converts movement of an output of the RET actuator to movement of a moveable element of the phase shifter.

3. The base station antenna of claim 24, wherein the first metal tuning element is mounted on an element of the mechanical linkage.

4. (canceled)

5. The base station antenna of claim 3, wherein the element of the mechanical linkage comprises a connecting rod that is mounted rearwardly of the reflector, and the first metal tuning element is connected to the connecting rod through an opening in the reflector.

6. The base station antenna of claim 24, wherein movement of the element of the mechanical linkage from a first position to a second position is configured to change a position of the first metal tuning element.

7. (canceled)

8. The base station antenna of claim 1, further comprising a second metal tuning element, wherein the second metal tuning element is mounted in a fixed position.

9. The base station antenna of claim 8, wherein the first metal tuning element is configured to cover at least a portion of the second metal tuning element when the first metal tuning element is moved from a first position to a second position.

10-11. (canceled)

12. The base station antenna of claim 1, wherein the array of radiating elements includes a plurality of columns of radiating elements that extend in a longitudinal direction of the base station antenna, and the first metal tuning element is configured to move in the transverse direction between first and second of the plurality of columns.

13. The base station antenna of claim 1, wherein the array of radiating elements includes a plurality of columns of radiating elements that extend in a longitudinal direction of the base station antenna, and the first metal tuning element comprises at least one isolation wall that extends in the longitudinal direction between first and second of the plurality of columns.

14-15. (canceled)

16. A base station antenna, comprising:
a reflector;
an array of radiating elements, the radiating elements mounted to extend forwardly from the reflector; and
a metal tuning element that includes at least a first metal tuning piece and a second metal tuning piece that are at least partly positioned in front of the reflector, where the first metal tuning piece is configured to move relative to the second metal tuning piece.

17. The base station antenna of claim 16, wherein the first metal tuning piece is configured to move to cover an outer surface of the second metal tuning piece.

18. The base station antenna of claim 16, wherein the first metal tuning piece is configured to move so that the second metal tuning piece covers an outer surface of the first metal tuning piece.

19. The base station antenna of claim 16, further comprising:
a phase shifter that is part of a feed network for the array of radiating elements; and
a mechanical linkage that converts movement of an output of the RET actuator to movement of a moveable element of the phase shifter,
wherein the first metal tuning piece is mounted on an element of the mechanical linkage.

20. The base station antenna of claim 19, wherein the element of the mechanical linkage comprises a connecting rod.

21. The base station antenna of claim 20, wherein the connecting rod is mounted rearwardly of the reflector, and the first metal tuning piece is connected to the connecting rod through an opening in the reflector.

22. (canceled)

23. The base station antenna of claim 16, wherein the array of radiating elements extends in a longitudinal direction of the base station antenna, and the first metal tuning piece is configured to move in the longitudinal direction.

24. A base station antenna, comprising:
a reflector;
a remote electronic tilt (“RET”) actuator;
a multi-column array of radiating elements, the radiating elements mounted to extend forwardly from the reflector;
a plurality of phase shifters; and
a plurality of connecting rods, where each connecting rod is configured to drive a respective moveable element on one or more of the phase shifters in response to movement of the RET actuator,
where at least some of the connecting rods have respective metal tuning elements mounted thereon.

25. The base station antenna of claim 24, wherein each connecting rod extends between a pair of adjacent columns of radiating elements.

26. The base station antenna of claim 24, wherein the metal tuning element comprises an isolation wall that extends between first and second of the columns of radiating elements

27-28. (canceled)

29. The base station antenna of claim 16, wherein movement of the metal tuning element is configured to improve inter-band isolation performance of the multi-column array of radiating elements.

30-34. (canceled)
